(19) United States
(12) Patent Application Publication
(10) Pub. No.: US 2026/0340347 A1
(43) Pub. Date: Oct. 29, 2026

(54) System, Program and Method for Performing Autoencoding

(71) Applicant: NATIONAL INSTITUTE OF INFORMATION AND COMMUNICATIONS TECHNOLOGY, Koganei-shi, Tokyo (JP)

(72) Inventor: Kazufumi Hosoda, Koganei-shi, Tokyo (JP)

(21) Appl. No.: 19/107,760

(22) PCT Filed: Aug. 24, 2023
(86) PCT No.: PCT/JP2023/030480

§ 371 Date: Feb. 28, 2025

(30) Foreign Application Priority Data
Sep. 15, 2022 (JP) 2022-146887

(51) Int. Cl. G06N 3/0455

(52) U.S. Cl. CPC G06N 3/0455

(57) ABSTRACT

Each of a first input node, a second input node, a hub node, an auxiliary node, a first output node, and a second output node outputs at least one of a positive signal representing a state value of the node and a negative signal representing a value having a sign inverted from a sign of the state value. Each of the first input node, the second input node, the hub node, the auxiliary node, the first output node, and the second output node changes the state value of the node such that a value determined by adding a noise signal received by the node to a value determined by subtracting the state value of the node from an activation value corresponding to a total value of signals input to the node is equal to a time derivative value of the state value of the node.

### TECHNICAL FIELD

The present disclosure relates to a system, a program and a method for performing autoencoding.

### BACKGROUND

Conventionally, there has been known a configuration for performing autoencoding. For example, Diederik P. Kingma, Max Welling, “Auto-Encoding Variational Bayes,” arXiv:1312.6114 discloses a variational autoencoder of an encoder-decoder model, which is formed as a neural network. The variational autoencoder extracts latent variables of a lower dimension than input data from the input data, and reproduces output data corresponding to the input data from the latent variables. According to the variational autoencoder, important features of the input data can be extracted as the latent variables, and thus, generalization performance of an inference model and a reduction in computational effort can be achieved.

It is known that a life system (e.g., a cranial nerve network or a cell signaling network) is formed as a dynamic network (a dynamic system with large degrees of freedom) which is composed of many elements and changes constantly, and performs efficient information processing by utilizing noise such as thermal fluctuation.

In an artificially designed information processing system, on the other hand, it is often the case that noise is suppressed as a disturbance that interferes with information processing, and is not actively used. In order to implement reliable information processing in the artificial information processing system, it is necessary to increase a signal-to-noise ratio (S/N ratio) by using a signal of higher energy than the noise to the extent that the effect of the noise can be ignored. As a result, it is often the case that the energy required for information processing by the information processing system is higher than the energy required for comparable information processing by the life system.

### SUMMARY OF THE DISCLOSURE

The present disclosure has been made to solve the above-described problem, and an object thereof is to improve energy efficiency of an information processing system.

A system according to one aspect of the present disclosure encodes a first input signal and a second input signal and then decodes respective encoded signals as a first output signal and a second output signal. The system includes a first input node, a second input node, a hub node, an auxiliary node, a first output node, and a second output node. The first input node receives the first input signal. The second input node receives the second input signal. The first output node outputs the first output signal. The second output node outputs the second output signal. Each of the first input node, the second input node, the hub node, the auxiliary node, the first output node, and the second output node outputs at least one of a positive signal representing a state value of the node and a negative signal representing a value having a sign inverted from a sign of the state value. The first input node outputs the negative signal of the first input node to each of the first input node and the hub node. The second input node outputs the negative signal of the second input node to the hub node. The hub node outputs the negative signal of the hub node to each of the hub node, the first output node, and the second output node. The auxiliary node outputs the positive signal of the auxiliary node to each of the hub node and the auxiliary node. The first output node outputs the positive signal of the first output node to the first output node, and outputs the positive signal of the first output node as the first output signal. The second output node outputs the positive signal of the second output node to each of the hub node and the second output node, and outputs the positive signal of the second output node as the second output signal. Each of the first input node, the second input node, the hub node, the auxiliary node, the first output node, and the second output node changes the state value of the node such that a value determined by adding a noise signal received by the node to a value determined by subtracting the state value of the node from an activation value corresponding to a total value of signals input to the node is equal to a time derivative value of the state value of the node.

A program according to another aspect of the present disclosure encodes a first input signal and a second input signal and then decodes respective encoded signals as a first output signal and a second output signal, in a system that receives the first input signal and the second input signal and outputs the first output signal and the second output signal. The system includes a first input node, a second input node, a hub node, an auxiliary node, a first output node, and a second output node. The first input node receives the first input signal. The second input node receives the second input signal. The first output node outputs the first output signal. The second output node outputs the second output signal. Each of the first input node, the second input node, the hub node, the auxiliary node, the first output node, and the second output node outputs at least one of a positive signal representing a state value of the node and a negative signal representing a value having a sign inverted from a sign of the state value. The first input node outputs the negative signal of the first input node to each of the first input node and the hub node. The second input node outputs the negative signal of the second input node to the hub node. The hub node outputs the negative signal of the hub node to each of the hub node, the first output node, and the second output node. The auxiliary node outputs the positive signal of the auxiliary node to each of the hub node and the auxiliary node. The first output node outputs the positive signal of the first output node to the first output node, and outputs the positive signal of the first output node as the first output signal. The second output node outputs the positive signal of the second output node to each of the hub node and the second output node, and outputs the positive signal of the second output node as the second output signal. The program is executed by a processor included in each of the first input node, the second input node, the hub node, the auxiliary node, the first output node, and the second output node, to thereby change the state value of the node such that a value determined by adding a noise signal received by the node to a value determined by subtracting the state value of the node from an activation value corresponding to a total value of signals input to the node is equal to a time derivative value of the state value of the node.

A method according to another aspect of the present disclosure encodes a first input signal and a second input signal and then decodes respective encoded signals as a first output signal and a second output signal, in a system that receives the first input signal and the second input signal and outputs the first output signal and the second output signal. The system includes a first input node, a second input node, a hub node, an auxiliary node, a first output node, and a second output node. The first input node receives the first input signal. The second input node receives the second input signal. The first output node outputs the first output signal. The second output node outputs the second output signal. Each of the first input node, the second input node, the hub node, the auxiliary node, the first output node, and the second output node outputs at least one of a positive signal representing a state value of the node and a negative signal representing a value having a sign inverted from a sign of the state value. The first input node outputs the negative signal of the first input node to each of the first input node and the hub node. The second input node outputs the negative signal of the second input node to the hub node. The hub node outputs the negative signal of the hub node to each of the hub node, the first output node, and the second output node. The auxiliary node outputs the positive signal of the auxiliary node to each of the hub node and the auxiliary node. The first output node outputs the positive signal of the first output node to the first output node, and outputs the positive signal of the first output node as the first output signal. The second output node outputs the positive signal of the second output node to each of the hub node and the second output node, and outputs the positive signal of the second output node as the second output signal. The method includes, by each of the first input node, the second input node, the hub node, the auxiliary node, the first output node, and the second output node, calculating a total value of signals input to the node, and changing the state value of the node such that a value determined by adding a noise signal received by the node to a value determined by subtracting the state value of the node from an activation value corresponding to the total value is equal to a time derivative value of the state value of the node.

According to a system, a program and a method in the present disclosure, each of a first input node, a second input node, a hub node, an auxiliary node, a first output node, and a second output node changes a state value of the node such that a value determined by adding a noise signal received by the node to a value determined by subtracting the state value of the node from an activation value corresponding to a total value of signals input to the node is equal to a time derivative value of the state value of the node, and thus, energy efficiency of the system can be improved.

### BRIEF DESCRIPTION OF DRAWINGS

FIG. 1 is a block diagram showing a configuration of an information processing system according to an embodiment.

FIG. 2 shows twelve time charts representing temporal changes in a state value of a hub node and temporal changes in state values of output nodes corresponding to four types of input signals, in the case where the information processing system has a S/N ratio of 10 dB.

FIG. 3 shows four time charts representing temporal changes in the state value of the hub node and temporal changes in the state values of the output nodes corresponding to the four types of input signals, in the case where a noise signal is 0 (in the case where there is no noise signal).

FIG. 4 shows a change in a potential energy curve of a first output node in the case where the input signals are switched from {0, 0} to {1, 0}.

FIG. 5 shows a change in a potential energy curve of a second output node in the case where the input signals are switched from {0, 0} to {1, 0}.

FIG. 6 is a block diagram showing an example hardware configuration of a node shown in FIG. 1.

FIG. 7 is a flowchart showing an example flow of a process performed by a processor that executes an autoencoding program shown in FIG. 6.

FIG. 8 is a block diagram showing a configuration of an information processing system according to a modification of the embodiment.

### DETAILED DESCRIPTION

Embodiments will be hereinafter described in detail with reference to the drawings, in which the same or corresponding portions are denoted by the same reference characters and description thereof will not be repeated in principle.

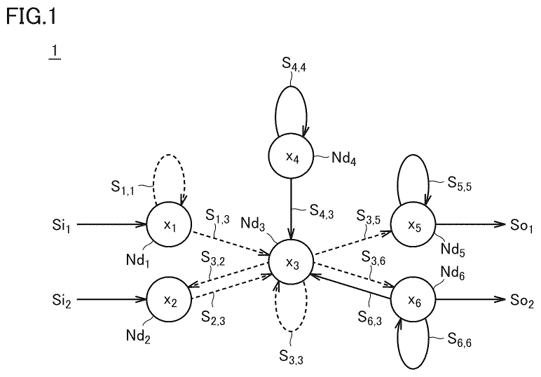

FIG. 1 is a block diagram showing a configuration of an information processing system 1 according to an embodiment. Information processing system 1 may be formed, for example, as an analog integrated circuit included in a computer, or as an edge computing system including a plurality of edge nodes. Information processing system 1 may be formed as part of a larger-scale information processing system.

As shown in FIG. 1, information processing system 1 encodes an input signal Si₁ (a first input signal) and an input signal Si₂ (a second input signal) and then decodes respective encoded signals as an output signal So₁ (a first output signal) and an output signal So₂ (a second output signal). Information processing system 1 includes an input node Nd₁ (a first input node), an input node Nd₂ (a second input node), a hub node Nd₃, an auxiliary node Nd₄, an output node Nd₅ (a first output node), and an output node Nd₆ (a second output node).

Input nodes Nd₁ and Nd₂ receive input signals Si₁ and Si₂, respectively. Output nodes Nd₅ and Nd₆ output output signals So₁ and So₂, respectively. In information processing system 1, two-dimensional input signals Si₁ and Si₂ are encoded as a one-dimensional state value x₃ of hub node Nd₃, and state value x₃ is decoded into two-dimensional output signals So₁ and So₂.

Each of input nodes Nd₁ and Nd₂, hub node Nd₃, auxiliary node Nd₄, and output nodes Nd₅ and Nd₆ (a node Ndᵢ (where i is a natural number equal to or greater than 1 and equal to smaller than 6)) outputs at least one of a positive signal representing a state value xᵢ of node Ndᵢ and a negative signal representing a value having a sign inverted from a sign of state value xᵢ. The positive signal and the negative signal are indicated by a solid arrow and a dotted arrow, respectively, in FIG. 1. State value xᵢ has an initial value of 0.

Input node Nd₁, input node Nd₂, hub node Nd₃, auxiliary node Nd₄, output node Nd₅, and output node Nd₆ form a network that can be represented as a directed graph. A signal output from a node Ndⱼ to Ndᵢ is hereinafter denoted by S_{j,i}.

Input node Nd₁ outputs negative signals S_{1,1} and S_{1,3} to input node Nd₁ and hub node Nd₃, respectively. Input node Nd₂ outputs a negative signal S_{2, 3} to hub node Nd₃. Hub node Nd₃ outputs negative signals S_{3, 3}, S_{3, 5}, and S_{3, 6} to hub node Nd₃, output node Nd₅, and output node Nd₆, respectively. Auxiliary node Nd₄ outputs positive signals S_{4,3} and S_{4, 4} to hub node Nd₃ and auxiliary node Nd₄, respectively. Output node Nd₅ outputs a positive signal S_{5,5} to output node Nd₅, and outputs a state value x₅ as output signal So₁. Output node Nd6 outputs positive signals S_{6,3} and S_{6,6} of output node Nd6 to hub node Nd3 and output node Nd6, respectively, and outputs a state value x₆ as output signal So₂.

An adjacency matrix C of the directed graph formed by input node Nd₁, input node Nd₂, hub node Nd₃, auxiliary node Nd₄, output node Nd₅, and output node Nd₆ is represented, for example, by an equation (1) below.

$$\begin{matrix}Math . 1 & \\ C = ( \begin{matrix}- 1 & 0 & 0 & 0 & 0 & 0 \\ 0 & 0 & - 1 & 0 & 0 & 0 \\ - 1 & - 1 & - 1 & 1 & 0 & 1 \\ 0 & 0 & 0 & 1 & 0 & 0 \\ 0 & 0 & - 1 & 0 & 1 & 0 \\ 0 & 0 & - 1 & 0 & 0 & 1\end{matrix} ) & ( 1 )\end{matrix}$$

In adjacency matrix C, a column number j (a natural number equal to or greater than 1 and equal to smaller than 6) represents node Ndⱼ which outputs a signal, and a row number i represents node Ndᵢ to which the signal is output. Each component of adjacency matrix C is any one of 1 representing a positive signal, −1 representing a negative signal, and 0 indicating that no signal is output from node Ndⱼ to Ndᵢ. Signal S_{j,i} is equal to the product of a component C_{i,j} and a state value xⱼ.

For example, a component C_{3,4} being 1 indicates that positive signal S_{4,3} (=1·x₄) is output from node Nd₄ to Nd₃. A component C_{5,3} being −1 indicates that negative signal S_{3,5} (=(−1)−x₃) is output from node Nd₃ to Nd₅. A component C_{1, 2} being 0 indicates that no signal is output from node Nd₂ to Nd₁ (that a signal S_{2,1} is 0 (=0·x₂)).

Each of node Nd₁, input node Nd₂, hub node Nd₃, auxiliary node Nd₄, output node Nd₅, and output node Nd₆ calculates a total value yᵢ of signals input to the node, as shown in an equation (2) below. A natural number N is 6 in information processing system 1. Natural number N may be equal to or greater than 7.

$$\begin{matrix}Math . 2 & \\ {y}_{𝔦} = {S}_{𝔦} + {\sum }_{j = 1}^{N} {C}_{i , j} \cdot {x}_{j} = {S}_{i} + {\sum }_{j = 1}^{N} {S}_{j , i} & ( 2 )\end{matrix}$$

In the equation (2), a signal Sᵢ is a total value of signals input to node Ndᵢ from a configuration other than nodes Nd₁ to Nd₆. For example, signals S₁ and S₂ correspond to input signals Si₁ and Si₂, respectively. Each of signals S₃, S₄, S₅ and S₆ is 0 because there are no signals input to nodes Nd₃ to Nd₆ from a configuration other than nodes Nd₁ to Nd₆.

Node Ndᵢ changes state value xᵢ of node Ndᵢ to satisfy an equation (3) below. In the equation (3), i represents a noise signal received by node Ndᵢ. Information processing system 1 has a S/N ratio of, for example, about 10 dB. The left-hand side of the equation (3) is a time derivative value of state value xᵢ. The first term of the right-hand side is an output value of an activation function (an activation value) for total value yᵢ. In the equation (3), a sigmoid function having a gain of β (>0) is used as an example of the activation function. Gain β is 10, for example. The activation function in the equation (3) is not limited to the sigmoid function. The activation function in the equation (3) may be, for example, a step function, a hyperbolic tangent function, or a ramp (rectified linear unit (ReLU)) function.

$$\begin{matrix}Math . 3 & \\ \frac{{dx}_{i}}{dt} = \frac{1}{1 + exp ( - β \cdot {y}_{i} )} - {x}_{i} + η & ( 3 )\end{matrix}$$

As shown in the equation (3), node Ndᵢ changes state value xᵢ of node Ndᵢ such that a value determined by adding noise signal i to a value determined by subtracting state value xᵢ from the activation value corresponding to total value yᵢ is equal to the time derivative value of state value xᵢ.

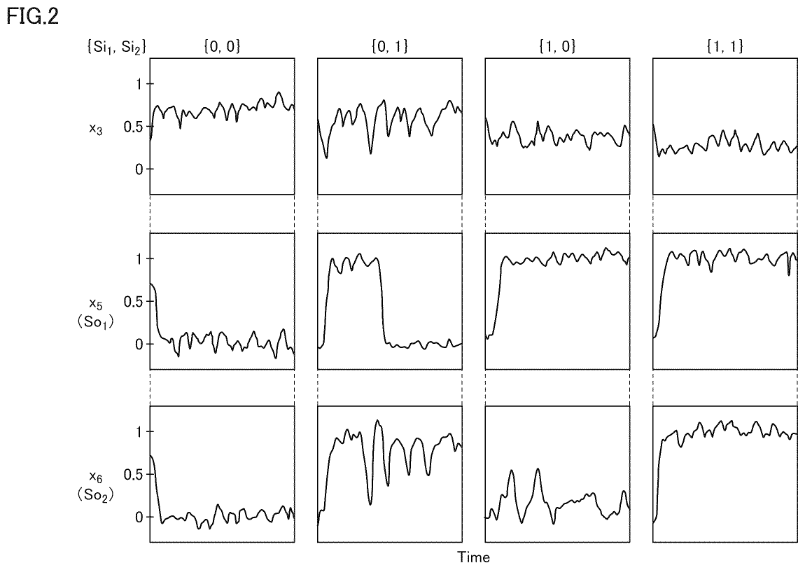

FIG. 2 shows twelve time charts representing temporal changes in state value x₃ of hub node Nd₃ and temporal changes in state values x₅ and x₆ of output nodes Nd₅ and Nd₆ corresponding to four types of input signals Si₁ and Si₂, in the case where information processing system 1 has a S/N ratio of 10 dB. FIG. 2 shows the cases where input signals Si₁ and Si₂ are {0, 0}, {0, 1}, {1, 0} and {1, 1} in the first, second, third and fourth columns, respectively.

As shown in FIG. 2, in each of the cases where input signals Si₁ and Si₂ are {0, 0}, {0, 1}, {1, 0} and {1, 1}, state values x₅ and x₆ (output signals So₁ and So₂) reach equilibrium near the values of input signals Si₁ and Si₂, respectively, as time passes. That is, information processing system 1 has the function of an autoencoder (autoencoding function).

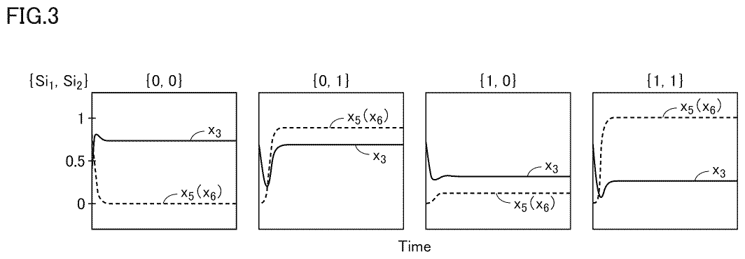

FIG. 3 shows four time charts representing temporal changes in state value x₃ of hub node Nd₃ and temporal changes in state values x₅ and x₆ of output nodes Nd₅ and Nd₆ corresponding to the four types of input signals Si₁ and Si₂, in the case where noise signal η is 0 (in the case where there is no noise signal). In FIG. 3, the temporal changes in state values x₃, x₅ and x₆ corresponding to one set of input signals Si₁ and Si₂ are included in one time chart.

As shown in FIG. 3, in the case where input signals Si₁ and Si₂ are equal to each other, state values x₅ and x₆ (output signals So₁ and So₂) reach equilibrium near the values of input signals Si₁ and Si₂, respectively, as time passes. In the case where input signals Si₁ and Si₂ are different each other, however, state value x₅ reaches equilibrium near an opposite value to that of input signal Si₁. That is, in the case where there is no noise signal, information processing system 1 does not function as an autoencoder. This indicates that noise signal η is actively used as a means for performing the autoencoding function and is not a disturbance to be suppressed in information processing system 1. Information processing system 1 does not need to increase the energy of input signals Si₁ and Si₂ to the extent that the effect of noise signal i can be ignored, and thus, the energy efficiency can be improved.

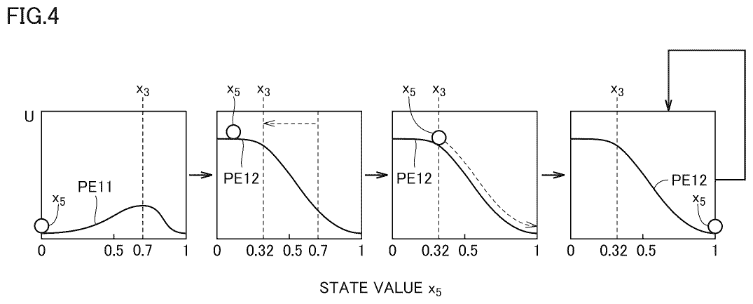

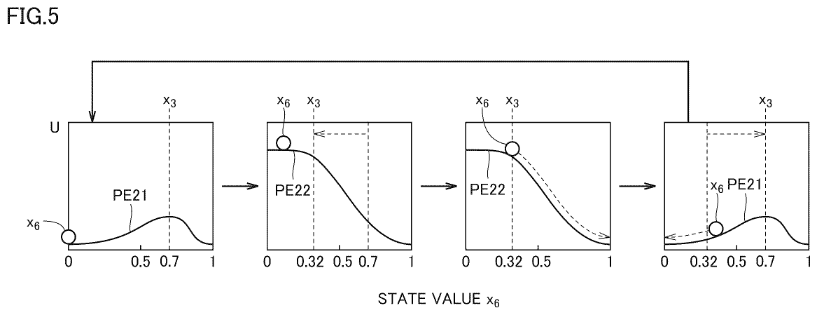

With reference to FIGS. 4 and 5, the following describes a mechanism by which information processing system 1 functions as an autoencoder even in the case where input signals Si₁ and Si₂ are different from each other. FIG. 4 shows a change in a potential energy curve of output node Nd₅ in the case where input signals Si₁ and Si₂ are switched from {0, 0} to {1, 0}. The potential energy curve is a curve indicating correspondence between a state value and potential energy U of a corresponding node. A point with a zero slope on the potential energy curve is hereinafter also referred to as a stable point of the state value corresponding to the potential energy curve. The potential energy is an indicator of instability of the state value, and corresponds to a value determined by integrating force over position in a dynamic system. The state value changes in a direction in which the potential energy decreases. State value x₃ is indicated by a dotted line in FIG. 4. To facilitate understanding of a change in state value x₅, state value x₅ is schematically shown as a circle rolling on the potential energy curve. The same is true for FIG. 5 which will be described later.

Referring to FIG. 4, before input signals Si₁ and Si₂ are switched from {0, 01 to {1, 01, it is supposed that state value x₃ is a value around 0.7, the potential energy curve of output node Nd₅ is PE11, and state value x₅ is stable at 0 on potential energy curve PE11. That is, a point corresponding to 0 on potential energy curve PE11 is a stable point of state value x₅.

Then, when the input signals are switched from {0, 01 to {1, 0} and state value x₃ decreases to 0.32 accordingly, the potential energy curve changes from PE11 to PE12. Although a point corresponding to 0 is a stable point of state value x₅ on potential energy curve PE12 as well, negative signal S_{3,5} output from hub node Nd₃ to output node Nd₅ increases to −0.32, and the suppression of state value x₅ by negative signal S_{3,5} is therefore relaxed. In such a state, state value x₅ may slightly increase by noise signal 1. When state value x₅ increases, potential energy curve PE12 is downwardly sloped, and state value x₅ therefore moves in a downwardly sloped manner on potential energy curve PE12 and reaches around 1. Since state value x₃ is not influenced by state value x₅, the potential energy curve does not change from PE12. Since potential energy curve PE12 with state value x₅ around 1 has a zero or negative (downward) slope, state value x₅ converges around 1. That is, state value x₅ reaches equilibrium around 1.

FIG. 5 shows a change in a potential energy curve of output node Nd₆ in the case where input signals Si₁ and Si₂ are switched from {0, 01 to {1, 01. Referring to FIG. 5, before input signals Si₁ and Si₂ are switched from {0, 01 to {1, 01, it is supposed that state value x₃ is a value around 0.7, the potential energy curve of output node Nd₆ is PE21, and state value x₆ is stable at 0 on potential energy curve PE21. That is, a point corresponding to 0 on potential energy curve PE21 is a stable point of state value x₆. Since the forces (negative signals S_{3,5} and S_{3, 6}) applied to output nodes Nd₅ and Nd₆ from hub node Nd₃ are always the same, potential energy curve PE21 is equal to potential energy curve PE11 shown in FIG. 4.

Then, when the input signals are switched from {0, 0} to {1, 01 and state value x₃ decreases to 0.32 accordingly, the potential energy curve changes from PE21 to PE22. Although a point corresponding to 0 is a stable point of state value x₆ on potential energy curve PE22 as well, the negative signal output from hub node Nd₃ to output node Nd₆ increases to −0.32, and the suppression of state value x₆ by negative signal S_{3, 6} is therefore relaxed. In such a state, state value x₆ may slightly increase by noise signal η. When state value x₆ increases, potential energy curve PE22 is downwardly sloped, and positive signal S_{6, 3} output from output node Nd₆ to hub node Nd₃ increases, and state value x₃ therefore increases. As a result, when state value x₃ increases from 0.32, for example, the potential energy curve returns to PE21 from PE22 before state value x₆ reaches a value around 0.7. As a result, state value x₆ does not increase from around 0. That is, state value x₆ reaches equilibrium around 0.

In the case where input signals Si₁ and Si₂ are switched from {0, 01 to {0, 1}, state value x₃ decreases immediately after the switching, and both of state values x₅ and x₆ therefore increase to around 1. Then, state value x₅ changes according to a potential energy curve obtained by line-symmetrically inverting potential energy curve PE12 shown in FIG. 4, and converges around 0. State value x₆ changes according to a potential energy curve obtained by line-symmetrically inverting potential energy curve PE22 shown in FIG. 5, and converges around 1.

In information processing system 1, a global optimal solution is searched for by noise signals, as in an annealing method. Additionally, in information processing system 1, input signals Si₁ and Si₂ are encoded into time-series data of state value x₃ (temporal coding or dynamic coding). Furthermore, in information processing system 1, state value x₃ is dynamically changed by noise signal η, to dynamically change the potential energy curve of each of output nodes Nd5 and Nd6.

A genetic algorithm (see Masayo Inoue, Kunihiko Kaneko, “Cooperative Adaptive Responses in Gene Regulatory Networks with Many Degrees of Freedom,” PLOS Computational Biology, Apr. 4, 2013, 9(4): e1003001) can be used, for example, to search for the network of information processing system 1 shown in FIG. 1. Specifically, each element is randomly determined from among −1, 0 and 1, to thereby generate a plurality of (e.g., a hundred) adjacency matrices C1. An evaluation index of the autoencoding function of a network corresponding to each of the plurality of adjacency matrices C1 is calculated, and the plurality of adjacency matrices C1 are ranked in descending order of the evaluation index. Of the plurality of adjacency matrices C1, a plurality of adjacency matrices C2 ranked equal to or higher than a predetermined rank (e.g., 25th) are identified. A predetermined number of (e.g., three) adjacency matrices C3 are generated from each of the plurality of adjacency matrices C2. The plurality of adjacency matrices C3 are adjacency matrices in which each element of corresponding adjacency matrix C2 is replaced with a value different from the element from among −1, 0 and 1 with a predetermined probability (e.g., 1% to 10%). The calculation of the evaluation index of the autoencoding function and the subsequent process are repeated for the plurality of adjacency matrices C3 generated from the plurality of adjacency matrices C2.

The evaluation index of the autoencoding function is the sum of absolute values of differences between output signals So₁, So₂ and input signals Si₁, Si₂ in the case where the plurality of input signals Si₁ and Si₂ ({0, 0}, {0, 1}, {1, 0}, {1, 1}) are input to the network corresponding to each of the plurality of adjacency matrices C1, plus the sum of absolute values of differences between output signals So₁, So₂ and {0, 0} in the case where input signals Si₁ and Si₂ are returned to {0, 0}. In order to reflect vibration states and the like of output signals So₁ and So₂ in the evaluation index, average values of output signals So₁ and So₂ from the time when half of a predetermined standby time elapses since the input of input signals Si₁ and Si₂ to the network to the time when the standby time elapses may be used as output signals So₁ and So₂.

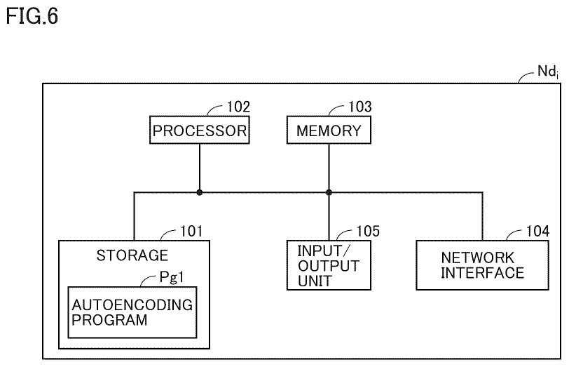

The following describes the case where information processing system 1 is formed as an edge computing system. In this case, node Ndᵢ forms an edge node. FIG. 6 is a block diagram showing an example hardware configuration of node Ndᵢ shown in FIG. 1. As shown in FIG. 6, node Ndᵢ includes a storage 101, a processor 102, a memory 103, a network interface 104, and an input/output unit 105.

Storage 101 is a nonvolatile storage device and includes, for example, a hard disk or an external storage medium. Storage 101 stores, for example, an operating system program (not shown) and an autoencoding program Pg1.

Processor 102 performs the functions of information processing system 1 by executing the various programs stored in storage 101. Processor 102 includes, for example, a central processing unit (CPU) or a graphics processing unit (GPU). When processor 102 of each node Ndᵢ included in information processing system 1 executes autoencoding program Pg1, the autoencoding function of information processing system 1 is performed. Processor 102 transmits data to and receives data from an external device connected to the Internet via network interface 104.

Memory 103 is a volatile storage device and includes, for example, a random access memory (RAM). Memory 103 functions as a working memory, and temporarily stores various types of data required for execution of the programs.

Input/output unit 105 receives an operation from a user, and outputs a processing result of a program corresponding to the operation to the user. Input/output unit 105 includes, for example, a touch panel, a display, a lamp, and a speaker.

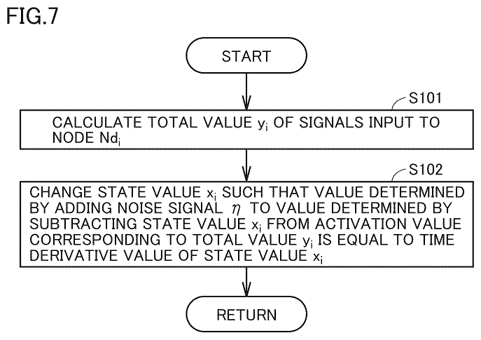

FIG. 7 is a flowchart showing an example flow of a process performed by processor 102 that executes autoencoding program Pg1 shown in FIG. 6. The process shown in FIG. 7 is invoked for each sampling time, for example, by a (not shown) main routine that comprehensively controls node Ndᵢ. Step is hereinafter abbreviated simply as S.

As shown in FIG. 7, processor 102 calculates total value yᵢ of signals input to node Ndᵢ in S101, and moves the process to S102. Processor 102 changes state value xᵢ such that a value determined by adding noise signal i to a value determined by subtracting state value xᵢ from an activation value corresponding to total value yᵢ is equal to a time derivative value of state value xᵢ, and moves the process back to the main routine.

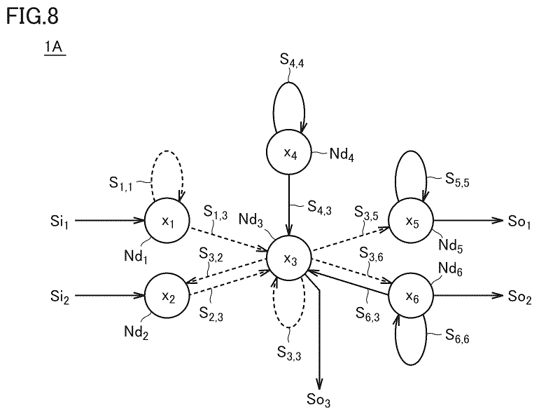

FIG. 8 is a block diagram showing a configuration of an information processing system 1A according to a modification of the embodiment. The configuration of information processing system 1A is that an output signal So₃ representing state value x₃ is output to outside of information processing system 1A from hub node Nd₃ in information processing system 1 shown in FIG. 1. As the configuration of information processing system 1A is otherwise the same as that of information processing system 1, description about the same configuration will not be repeated. State value x₃ is a feature amount of input signals Si₁ and Si₂ with the reduced dimension. According to information processing system 1A, the feature amount of input signals Si₁ and Si₂ can be obtained outside of information processing system 1.

As described above, according to the information processing system, the program and the method in each of the embodiment and the modification, the energy efficiency of the information processing system can be improved.

It should be understood that the embodiments disclosed herein are illustrative and non-restrictive in every respect. The scope of the present invention is defined by the terms of the claims, rather than the description above, and is intended to include any modifications within the meaning and scope equivalent to the terms of the claims.

1. A system for encoding a first input signal and a second input signal and then decoding respective encoded signals as a first output signal and a second output signal, the system comprising:
a first input node that receives the first input signal;
a second input node that receives the second input signal;
a hub node;
an auxiliary node;
a first output node that outputs the first output signal; and
a second output node that outputs the second output signal, wherein
each of the first input node, the second input node, the hub node, the auxiliary node, the first output node, and the second output node outputs at least one of a positive signal representing a state value of the node and a negative signal representing a value having a sign inverted from a sign of the state value,
the first input node outputs the negative signal of the first input node to each of the first input node and the hub node,
the second input node outputs the negative signal of the second input node to the hub node,
the hub node outputs the negative signal of the hub node to each of the hub node, the first output node, and the second output node,
the auxiliary node outputs the positive signal of the auxiliary node to each of the hub node and the auxiliary node,
the first output node outputs the positive signal of the first output node to the first output node, and outputs the positive signal of the first output node as the first output signal,
the second output node outputs the positive signal of the second output node to each of the hub node and the second output node, and outputs the positive signal of the second output node as the second output signal, and
each of the first input node, the second input node, the hub node, the auxiliary node, the first output node, and the second output node changes the state value of the node such that a value determined by adding a noise signal received by the node to a value determined by subtracting the state value of the node from an activation value corresponding to a total value of signals input to the node is equal to a time derivative value of the state value of the node.

2. The system according to claim 1, wherein the hub node outputs the state value of the hub node to outside of the system.

3. The system according to claim 1, wherein;
each of the first input node, the second input node, the hub node, the auxiliary node, the first output node, and the second output node is formed as an edge node, and
the edge node includes a processor, a memory, and a communication unit.

4. (canceled)

5. A method for encoding a first input signal and a second input signal and then decoding respective encoded signals as a first output signal and a second output signal, in a system that receives the first input signal and the second input signal and outputs the first output signal and the second output signal,
the system comprising:
a first input node that receives the first input signal;
a second input node that receives the second input signal;
a hub node;
an auxiliary node;
a first output node that outputs the first output signal; and
a second output node that outputs the second output signal, wherein;
each of the first input node, the second input node, the hub node, the auxiliary node, the first output node, and the second output node outputs at least one of a positive signal representing a state value of the node and a negative signal representing a value having a sign inverted from a sign of the state value,
the first input node outputs the negative signal of the first input node to each of the first input node and the hub node,
the second input node outputs the negative signal of the second input node to the hub node,
the hub node outputs the negative signal of the hub node to each of the hub node, the first output node, and the second output node,
the auxiliary node outputs the positive signal of the auxiliary node to each of the hub node and the auxiliary node,
the first output node outputs the positive signal of the first output node to the first output node, and outputs the positive signal of the first output node as the first output signal,
the second output node outputs the positive signal of the second output node to each of the hub node and the second output node, and outputs the positive signal of the second output node as the second output signal, and
the method includes, by each of the first input node, the second input node, the hub node, the auxiliary node, the first output node, and the second output node:
calculating a total value of signals input to the node, and
changing the state value of the node such that a value determined by adding a noise signal received by the node to a value determined by subtracting the state value of the node from an activation value corresponding to the total value is equal to a time derivative value of the state value of the node.
